(19) United States
(12) Patent Application Publication
(10) Pub. No.: US 2006/0277063 A1
(43) Pub. Date: Dec. 7, 2006

(54) Preventive healthcare program with low-cost prescription drug benefit patient enrollment system and method

(76) Inventors: Travis Leonardi, Lighthouse Point, FL (US); Paul Averill, Royal Palm Beach, FL (US)

Correspondence Address: Steven M. Greenberg, Esq.;Christopher & Weisberg, P.A., Suite 2040, 200 East Las Olas Boulevard, Fort Lauderdale, FL, 33301, US

(21) Appl. No.: 11/142,967

(22) Filed: Jun. 1, 2005

(51) Int. Cl. G06Q 10/00

(52) U.S. Cl. 705/2

(57) ABSTRACT

A method and system for providing a patient with beneficial and discounted healthcare services from a qualified healthcare facility. The system and method allows a patient to become enrolled in preventive healthcare system, where the patient receives preventive healthcare services from a contracted participating attending physician. The patient provides to the healthcare facility a description of the patient's current health status including the patient's current health-related symptoms. The healthcare facility provides intervention procedures recommended by pre-established healthcare guidelines and prepares a preventive healthcare program that permits patient's access to discounted prescription medications. The patient is required to maintain a relationship with the contracted physician to insure that the patient adheres to the intervention procedures. Failure on the patient's part to maintain the relationship with the physician may result in the dis-enrollment of the patient from the preventive healthcare program and a loss of associated benefits.

### BACKGROUND OF THE INVENTION

1. Statement of the Technical Field

The present invention relates to healthcare services and more particularly to a method and system for enrolling patients in a preventive healthcare program that incorporates a low-cost prescription drug benefit system and for designing a preventive-wellness program based upon the patient's current health status, the patient's enrollment status being maintained so long as the patient consults with a physician who monitors the patient's compliance with the prevention program.

2. Description of the Related Art

Throughout the years, there have been many advances in modern medicine relating to the mode of treatment of patients, and especially with regard to preventive healthcare and to the pharmaceuticals that are available to treat the patients. In particular, drug manufacturers are devoting large amounts of their resources into research and development of new pharmaceuticals, many of which are proving to effective in the treatment of long suffering patients. Based, however, upon the business model typically associated with the development and marketing of these innovative pharmaceuticals, and the virtual monopolies over certain medications that are often established by the pharmaceutical manufactures such as based upon patent protection and/or trade secret protection, the end cost of the pharmaceuticals to consumers is often very high. Indeed, while it is recognized that pharmaceutical development is a business aimed to the development of profits, the critical need of the pharmaceutical by patients, as well as the subsidization of the purchase of the pharmaceuticals by insurance companies and/or the Medicaid program, all have a tendency to promote the maintenance of high pharmaceutical prices by the manufacturers.

Unfortunately, in addition to the patients that have effective insurance coverage to help subsidize the purchase of necessary pharmaceuticals, there are also a large number of patients who do not have adequate insurance coverage and/or are merely members of discount card type programs. As a result, these patients must pay a substantial price for the purchase of necessary pharmaceuticals. Furthermore, it is also recognized that as the healthcare system changes, the practice of large percentage subsidization of pharmaceutical costs, even for insured patients covered by Medicaid or other policies, has an uncertain future. As a result, many current patients, as well as many patients in the future, are left to independently pay a substantial amount of the bill for the pharmaceuticals that are essential to their healthcare needs.

In recognizing the difficulties and perhaps the burden associated with having to purchase a continuous regimen of necessary pharmaceuticals at the often high pharmaceutical company prices, the United States government enacted its Public Health Services Act into law whereby certain healthcare facilities could be qualified as Federally Qualified Healthcare Centers or Federally Qualified Healthcare Center look-alikes (both, for purposes of clarity referred to as an “FQHC” in the present document) or disproportionate share hospitals as governed under Title 18 of the Social Security Act, and could therefore be eligible to participate in a Federal drug discount program.

In particular, in exchange for Medicaid qualification for their products and/or other benefits to the pharmaceutical companies, the pharmaceutical companies agreed to provide their pharmaceuticals to the FQHCs or qualified disproportionate share hospitals based upon an established discount cost schedule. As a result, patients of the FQHCs or disproportionate share hospitals would have the benefit of the pharmaceuticals at a reduced cost. Typically, FQHCs include indigent healthcare facilities, veteran facilitates as well as other federally organized healthcare facilities, including Indian tribal healthcare facilities. Unfortunately, however, for the typical patient, ordinary individuals suffering from chronic illnesses requiring extensive and expensive pharmaceuticals are traditionally qualified patients of the FQHCs or disproportionate share hospitals and are thus not eligible for the discounted medication.

As a result, it would be highly beneficial to provide a method and system of providing healthcare services to-patients, which is able to accept virtually all patients who require the healthcare service, is able to provide the patients with a significant and substantial healthcare service to help them manage chronic illness and/or other treatments, and which is achieved in a manner that also makes those patients eligible to benefit from the federal drug discount program available to FQHCs or disproportionate share hospitals.

Such a system and method should be established within the regulatory guidelines set forth by the government in establishing FQHC, disproportionate share hospital and drug discount program qualification without compromising the access to healthcare for existing or traditional patients of the FQHC or disproportionate share hospital, but rather increases the healthcare benefits that may be obtained by those patients as well as new patients that had traditionally been outside of the FQHCs or disproportionate share hospital's patient pool.

It is also desirable to provide a method and system that allows an eligible patient to maintain his or her eligibility by providing health-related symptoms to the healthcare service provider, allowing the service provider to match the symptoms with a database of illnesses and diagnoses in order to prescribe certain preventive healthcare services based upon the U.S. Preventive Services Task Force Guidelines along with proper treatment procedures, provides these services and treatment procedures to the patient in accordance with a personalized, tailored wellness program for each individual patient. It is further desirable to assure that the patient communicates with a physician regarding the wellness program and the patient's failure to do so may result in the dis-enrollment of that patient.

### SUMMARY OF THE INVENTION

The present invention relates to a method and system of providing patients with beneficial preventive healthcare services in a manner that also provides them with access to necessary pharmaceuticals at a reduced cost below what they would normally pay for such pharmaceuticals. Specifically, the present method and system allows patients to enroll in a preventive healthcare program via a qualified healthcare facility. The patient is required to adhere to a preventive healthcare program constructed by the healthcare facility and to maintain contact with a physician at the healthcare facility such that the physician assures that the patient is adhering to the preventive healthcare program. If the patient fails to either maintain communication with the physician or fails to adhere to the preventive healthcare program, the patient may be dis-enrolled from the preventive healthcare program.

In one aspect of the invention, a method for enrolling one or more patients in a preventive healthcare program is provided. The method includes storing at a healthcare facility a list of infirmities, where each infirmity includes a corresponding list of symptoms. The healthcare facility is a qualified member of the preventive healthcare program. The healthcare facility receives from the patient information regarding the status of the patient's health, wherein the patient's health status includes one or more symptoms. Upon receipt of the patient information, it is determined if the infirmity corresponds to the one or more symptoms and if so, a preventive healthcare plan based upon pre-established healthcare guidelines is generated. A relationship is established between a physician affiliated with the preventive healthcare program and the patient in order to assure the patient's adherence to the preventive healthcare program.

In another aspect of the invention, a system for enrolling one or more patients in a preventive healthcare program is provided. The system includes a healthcare facility, where the healthcare facility is a qualified member of the preventive healthcare program. The healthcare facility includes a database adapted to store a list of infirmities, where each infirmity includes a corresponding list of symptoms and treatment procedures. The healthcare facility is adapted to receive from the patient a communication of the patient's current health status, the patient's current health status including at least one or more patient symptoms. The system further includes means for determining one or more intervention procedures corresponding to the patient's one or more symptoms and for creating a preventive healthcare program corresponding to the one or more intervention procedures. The system also includes at least one physician associated with the healthcare facility. The physician or physicians establish a relationship with the patient regarding the preventive healthcare program, where the patient's failure to maintain relationship with the physician results in the dis-enrollment of the patient from the preventive healthcare program.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a diagram of an exemplary system constructed in accordance with the principles of the present invention; and

FIG. 2 is a flowchart illustrating the overall process of the present invention.

### DETAILED DESCRIPTION OF THE PREFERRED EMBODIMENTS

The present invention advantageously presents a method and system for providing a patient with beneficial and discounted healthcare services from a qualified healthcare facility, as well as enrollment in a preventive healthcare program. Specifically, the present system and method allows a patient to become enrolled in the preventive healthcare program, where the patient is put in communication with a physician at the healthcare facility. The patient provides to the healthcare facility a description of the patient's current health status including the patient's current symptoms, if any. The healthcare facility matches the symptoms to a listing of infirmities and prepares a preventive healthcare program based upon treatment procedures for the patient's infirmity. The patient is required to maintain a patient-physician relationship with an attending physician at the healthcare facility in order to insure that the patient adheres to the preventive healthcare program. Failure on the patient's part to maintain communication or failure to adhere to the wellness program may result in the dis-enrollment of the patient from the preventive healthcare program.

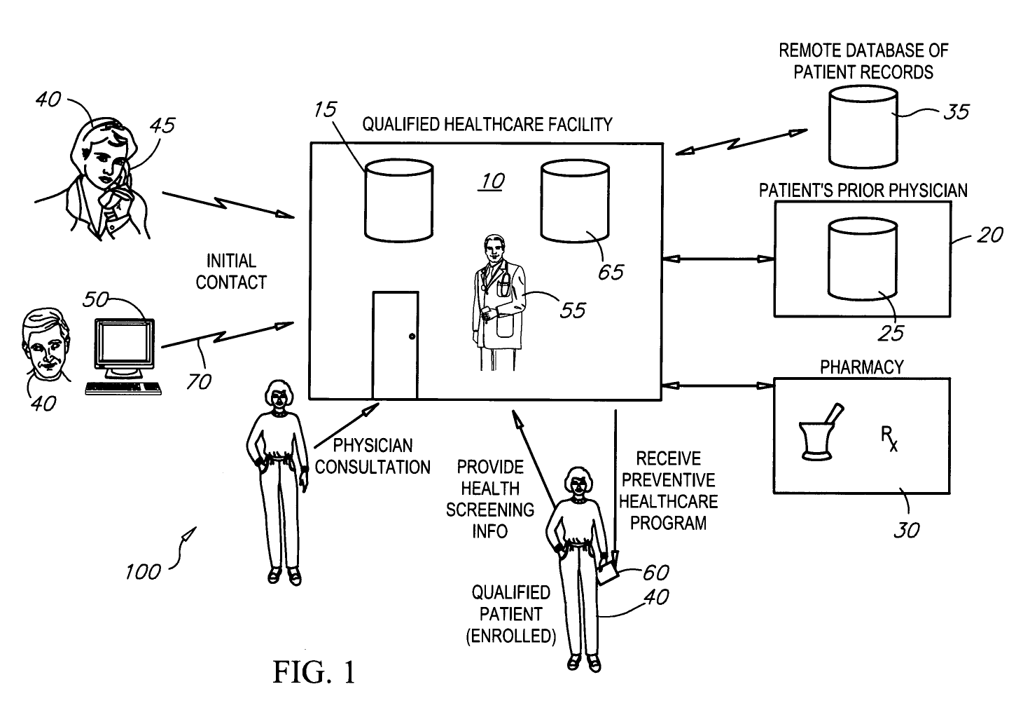

Referring now to the drawing figures in which like reference designators refer to like elements there is shown in FIG. 1 a system constructed in accordance with the principles of the present invention and designated generally as “100”. System 100 includes a qualified healthcare facility 10. It is preferred that healthcare facility 10 be qualified as a Federally Qualified Healthcare Center or Federally Qualified Healthcare Center Equivalent (both, for purposes of clarity, referred to as an “FQHC” in the present document), within the meaning of 42 U.S.C.§256(b), namely the Public Health Service Act, or a disproportionate share hospital, within the meaning of Title 1B of the Social Security Act.

Moreover, the Public Health Services Act also establishes a federal drug discount program under §340B. In order to benefit from this federal drug discount program and preferably the §340B drug discount program, a healthcare facility must be eligible for that benefit, such as by being qualified as an FQHC or disproportionate share hospital with attendant §340(b) qualifications.

Specifically, §340B requires pharmaceutical manufacturers, whose drugs are covered by the Medicaid program, to enter into a second agreement with the Secretary of Health and Human Services (HHS), whereby they would agree to provide discounts on covered drugs to specified government supported facilities. Among these government supported facilities are dis-proportionate share hospitals, owned or under contract with state or local governments, as well as specified grantees including FQHCs and qualified disproportionate share hospitals, according to the Public Health Service Act.

Along these lines, within the meaning of the method or system of the present invention, qualified healthcare facility 10 may include all or part of an FQHC or disproportionate share hospital, including a separate affiliate healthcare facility that is or becomes associated with a newly established or pre-established FQHC or disproportionate share hospital, and therefore becomes a qualified facility by virtue of the association.

For example, in one embodiment of the present invention, an already established healthcare center that qualifies as an FQHC or disproportionate share hospital can become associated with an affiliate healthcare center. This affiliate healthcare center can be commonly or independently owned and managed by being associated with and preferably operated by the FQHC or disproportionate share hospital. It will also retain FQHC or disproportionate share hospital status such that it would also be eligible for the federal discount drug program as an operating entity of the pre-established FQHC or disproportionate share hospital. Of course, it is recognized that a brand new entity, which is to be established as an FQHC or disproportionate share hospital can also be utilized, and/or the FQHC or disproportionate share hospital itself can internally expand or modify its services so as to independently define the qualified healthcare facility of the present invention.

In one embodiment, the pre-established FQHC or disproportionate share hospital is preferably, but not necessarily, an Indian Tribal Healthcare Facility established under the Indian Healthcare Act, and thus qualified as an FQHC eligible to participate in a federal drug discount program such as the §340B drug discount program. The qualified healthcare facility 10 is therefore appropriately defined. The healthcare facility 10 also preferably retains the services of at least one attending physician 55, and typically a plurality of physicians 55 and associated staff which define individually and/or as a whole, a treatment staff of the healthcare facility 10.

Of course, it is understood that the treatment staff may include only a single physician, however, for purposes of providing the highest quality care to a patient, preferably a number of physicians and associated healthcare professionals and support personnel will be retained by healthcare facility 10. Additionally, in the preferred embodiments, at least one physician retained by healthcare facility 10 will be telemedicine licensed. Thus, patient 40, in order to be eligible for discounted pharmaceuticals under the preventive healthcare program, must establish and maintain a professional relationship with an attending physician 55. Physician 55 can either be employed by facility 10, or be contracted to do business with facility 10 (and therefore still part of the preventive healthcare program). In addition, the physician may be one that enjoys a referral relationship with physician 55.

The Federation of State Medical Boards has established criteria for telemedicine standards of practice, which many, if not all, states accept, and many states actually provide the telemedicine licensing. As a result, whether or not specific licensing is required, pursuant to the standards and practices of telemedicine or equivalent methods, by the state, in one embodiment of the invention, at least one physician will be telemedicine licensed so as to provide quality standards for telephony or remote communication with patient 40 as defined by the Federation of State Medical Board, and so as to ensure appropriate qualification of the physician(s) in those states that do require the licensing.

Referring again to FIG. 1, a patient 40 makes initial contact with healthcare facility 10 via either telephone 45 or computer 50 coupled to a communication system such as Internet 70. Patient 40 thus need not be physically present at the healthcare facility 10 in order to make the initial contact with healthcare facility 10 and to obtain enrollment in the federal discount drug program. However, patient 40 may choose to meet with a staff person at the healthcare facility 10 or to meet directly with one of its doctors prior to obtaining enrollment in the program.

Healthcare facility 10 may also contain a patient record database 15, which contains patient records, including each patient's medical history, financial records and the like. In an alternate embodiment, a remote database 35 retains the patient's records at a facility remote from healthcare facility 10. Database 65 contains a list of medical infirmities, their symptoms, diagnoses, and treatment procedures. It too can be maintained either within healthcare facility 10 or in a remote location. The contents of this database will be used to determine if an enrollment patient is suffering from a known infirmity. If necessary, healthcare facility 10 may receive patient medical information from each patient's prior or referring physician 20. Each patient's prior or referring physician presumably maintains a database 25 of their patient's medical history. These records may be transferred, either manually, or via a communication system such as an intranet, LAN or Internet system, to database 15 in healthcare facility 10.

After a patient 40 who wishes to enroll in the program contacts healthcare facility 10, patient identification information is provided to the healthcare facility, and the patient's medical records obtained and stored in database 15, it is determined if patient 40 qualifies for enrollment into the preventive healthcare program with a discount prescription drug benefit. The qualifying of a patient in the program will be discussed in greater detail below.

Once enrolled, a doctor-patient relationship is established. In one embodiment of the present invention, the communication between doctor 55 and patient 40 is initially achieved via telephone and/or a computerized network such as the Internet, and as a result, face-to-face and/or physical contact and/or examination of the patient is not required. In an alternate embodiment, patient 40 meets with doctor 55 so the doctor 55 can conduct a physical examination of the patient and the patient can feel more comfortable with the healthcare facility 10 and its physicians. In either event, preferably during communication with patient 40, healthcare records associated with patient 40 are also obtained and maintained in database 15. In particular, when initial communication with the patient 40 is made, such as by a member of the treatment staff of healthcare facility 10, a quantity of information is preferably obtained from patient 40 to at least partially define the healthcare records that are maintained and subsequently reviewed by the treatment staff, and preferably a treating physician.

In order to ensure quality guidelines, and also to effectively qualify the information received from patient 40 as healthcare records within the requisite guidelines for qualification of the patient for use of the federal drug discount program, the information that is received may be commensurate to that required to complete a standard Medicaid universal claim form and/or may indeed be an HCFA Form 1500, or successive versions of this form, that has been pre-established as an acceptable healthcare record by the appropriate governmental agencies. Moreover, with appropriate consent received from patient 40, it may also be preferred that instead of or in addition to gathering information from the patient, pre-existing healthcare records, such as those maintained by a prior care physician 20, are obtained and maintained to define the healthcare records for patient 40.

In this regard, the medical records are preferably obtained from physician 55 that has physically examined patient 40, and may be the patient's primary care physician and/or a specialized care physician. Based upon the initial communication with patient 40, the establishment of the healthcare records, and/or in some embodiments the consultation with the physician 55 that has physically examined patient 40, a patient consult is preferably executed. In this regard, it is noted that although a physical examination of patient 40 may be performed or required as all or part of the patient consult, in one embodiment, the patient consult will be executed, so as to make the patient a qualified patient of the healthcare facility 10, pursuant to the standards and practices of telemedicine or equivalent methods, without physical examination by the treatment staff of the qualified healthcare facility.

Even though in some embodiments, obtaining and maintaining the healthcare records as well as a remote communication with patient 40 by the treatment staff may be sufficient so as to qualify patient 40 as a patient of healthcare facility 10, in one embodiment and also as part of execution of the patient consult, a member of the treatment staff, or preferably a treating physician 55, will communicate with the prior treating physician 20, such as via telephone in order to verify information and/or a diagnostic history. As such, by communicating with the prior care physician 20 that has had physical contact and examination of patient 40, an acceptable patient consult is achieved and patient 40 is qualified as an appropriate patient of healthcare facility 10 eligible to receive healthcare services and other benefits, including reduced-cost pharmaceuticals from a participating pharmacy 30, and/or from healthcare facility 10.

Although it is recognized that in the one embodiment a series of individual steps may be undertaken, many if not all of these steps associated with communicating with patient 40, gathering and maintaining records and/or establishing a patient consult, can be achieved substantially simultaneously or as may be most convenient for patient 40 in order to qualify them as the patient of healthcare facility 10 and provide them with the beneficial healthcare services that they require. Nevertheless, utilizing the recited steps of the present method, whether separately or simultaneously, the patient can be effectively qualified as a patient of healthcare facility 10 and can be eligible for full benefits pursuant to the Office of Pharmacy Affairs' guidelines for eligibility to the federal discount drug program.

Referring once again to FIG. 1, it can be seen that patient 40 supplies to healthcare facility 10 health screening information in order to qualify for enrollment in the federal discount drug program. The health screening information may include the status of the patient's current health, as well as symptoms of health-related problems that the patient may currently be suffering from. The symptoms are compared to a list of infirmities stored in database 65 in order to determine if patient 40 is suffering from a known illness. If a match is found, a preventive healthcare treatment plan is prepared, which is presented to patient 40. The preventive healthcare program is designed for each particular patient and may include intervention procedures. Intervention procedures are preventive diagnostic tests and procedures that are typically governed and recommended by the U.S. Preventive Services Task Force and usually depend upon the patient's age, sex and particular symptoms. The program may also include the dispensing of pharmaceutics, an exercise and/or diet regimen, and/or scheduled visits with a physician 55. The patient's adherence to the preventive healthcare program and his or her ongoing relationship with a participating attending physician 55 may determine whether patient 40 remains enrolled in the preventive healthcare program with access to discounted drugs.

Upon receiving the preventive healthcare program, patient 40 continues their communication with physician 55. Patient 40 can create a convenient schedule in order to meet with physician 55 or members of the physician's staff such that physician 55 can assure that patient 40 is following the program that was designed for them. Failure to maintain a patient-physician relationship with attending physician 55 or the physician's staff at the scheduled times may result in the dis-enrollment of patient 40. Further, if the patient 40 does not adhere to the preventive healthcare program that was designed for them, they may be dis-enrolled from the preventive healthcare program.

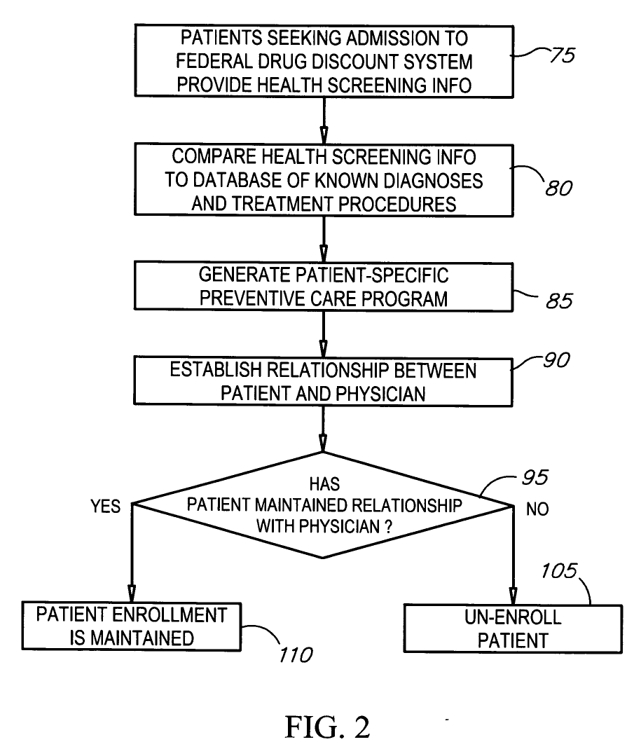

FIG. 2 illustrates the steps taken by the preventive healthcare program enrollment method of the present invention. Patients 40 seeking to gain admission to preventive healthcare program may contact the participating healthcare facility 10 and provide health screening information, via step 75. The health screening information may be supplied over the telephone, or the Internet, or by actually visiting healthcare facility 10. Typically, patient 40 receives a questionnaire and supplies responses to questions regarding the patient's current health. The questionnaire can be provided to the patient by mail, in-person, over the Internet, or be administered to the patient over the telephone. If the patient 40 is currently experiencing symptoms of some kind, these can be listed in the questionnaire response. The healthcare facility 10, upon receipt of the patient's health screening information including health-related symptoms, may compare the symptoms to a list of known infirmities in order to obtain a diagnosis of the patient's illness, via step 80. A physician 55 at healthcare facility 10 may request that patient 40 schedule an in-house visit to healthcare facility 10 in order to be examined.

After concluding that patient 40 is suffering from an illness, physician 55 may then prepare a patient-specific preventive healthcare program designed for patient 40, based upon pre-established healthcare guidelines such as the U.S. Preventive Services Task Force Guidelines, at step 85. Physician 55, or a staff member at healthcare facility 10 contacts patient 40 in order to arrange a physician-patient consult schedule, at step 90. Thus, a professional relationship is established between the physician and the patient. At this stage, patient 40 is enrolled in the preventive healthcare program and has received a preventive healthcare program that may include prescription drugs at a discounted rate in addition to medical advice as part of a preventive healthcare and treatment program.

Preferably, the preventive healthcare program includes healthcare services that are consistent with those services of the healthcare facility 10 that allowed and facilitated its qualification as an FQHC or disproportionate share hospital, although in the case of a disproportionate share hospital that may not be necessary as it does not receive grant money from the HRSA. In particular, as previously recited, only certain types of healthcare facilities are deemed FQHCs or disproportionate share hospitals, and are therefore eligible to participate in the federal drug discount program. In order to preserve FQHC or disproportionate share hospital status, when additional healthcare services are provided, either directly by the pre-established or newly established FQHC or disproportionate share hospital, or by the affiliated healthcare facility that becomes associated with the FQHC or disproportionate share hospital, the healthcare services that are provided must comply with the restrictions applicable to the FQHC or, in some cases, the disproportionate share hospital, for example, to be consistent with those services being offered when the facility was qualified as an FQHC or disproportionate share hospital in the first place.

As a result, if a particular FQHC or disproportionate share hospital has a dedicated specialization, healthcare services that are substantially different from that specialization may be inappropriate, and may jeopardize the eligibility of a patient receiving those healthcare services to participate in the preventive healthcare program and to access discounted prescription medications.

Looking further to the embodiment wherein the healthcare facility is qualified pursuant to the Indian Healthcare Act as an FQHC, the healthcare services to be offered to patients that are not part of the Indian population, in addition to being consistent with those services offered by Indian Tribal Healthcare facilities to members of the tribe, are also preferably performed in a manner which does not reduce or otherwise diminished services to the members of the tribe.

Moreover, in order to allow non-members of the tribe to receive services from the facility, the services, while consistent with existing services, are preferably not otherwise available, at least to the non-members of the tribe, in the operating area of the qualified healthcare facility. In any case, the healthcare facility must comply with the restrictions applicable to the FQHC or disproportionate share hospital.

In one embodiment of the present invention, the healthcare services that are provided to the qualified patient 40 by the qualified healthcare facility 10 include chronic care preventive healthcare services, whereby one or more members of the treatment staff, and preferably physician 55, reviews one or more intervention procedures and treatment regimens, preferably based upon the U.S. Preventive Services Task Force, that are currently being provided or prescribed to patient 40 by acting prior care physicians 20, and coordinates those treatment plans, especially as they relate to medication being administered. In particular, the treatment staff takes into account all treatments and advises the patient 40 on a variety of factors, including the effects of combining certain medications or treatments, alternate treatment plans, etc., so as to better help the patient more effectively manage the one or more treatment regimens.

For example, chronic care patients are often undergoing a number of specific, ongoing treatments regimens so as to treat and/or cure a long-term condition or a variety of different conditions. Moreover, in many circumstances, they have a number of active prior care physicians, each with a different specialization offering treatment regimens to patient 40, sometimes in isolation from one another.

As a result, the qualified healthcare facility 10 and in particular the treatment staff thereof is able to effectively monitor and coordinate all the various treatment regimens, and appropriately provide guidelines and recommendations to the qualified patient 40 which can greatly enhanced the quality of care they obtain and can significantly promote the beneficial and effective carrying out of the treatment regimens.

In this regard, recommendations are preferably provided to one or more of the acting prior care physicians 20, either directly by the treatment staff of the qualified healthcare facility 10 or via the patients themselves, those recommendations, when appropriate, preferably being implemented, at least in part, by an acting prior care physician 20. As a result, the qualified patient receives a substantial healthcare benefit not otherwise available to them, but consistent with the purpose of qualified healthcare facility 10. Of course, it is recognized that other healthcare services may also be provided to patients by the qualified healthcare facility 10.

In addition to providing the qualified patient with the preventive healthcare services, the qualified healthcare facility 10 also preferably obtains pharmaceuticals at a discounted cost utilizing the federal drug discount program. The qualified healthcare facility 10 may also appropriately dispense the pharmaceuticals obtained via the discount program at a reduced cost to patient 40. Naturally, the pharmaceuticals will be dispensed to patient 40 under a prescription basis when necessary and in accordance with the one or more treatment programs associated with the qualified patient 40. Nevertheless, the reduced cost as defined herein may be defined as at least below a normal retail cost for the pharmaceuticals, and in many circumstances is substantially below the normal retail cost and below the cost that may otherwise be achieved utilizing a traditional pharmaceutical discount card type program.

As previously mentioned, it is recognized that the qualified healthcare facility 10 may be an affiliated healthcare facility that becomes associated with a pre-established or newly established FQHC or disproportionate share hospital, and/or a pre-established FQHC or disproportionate share hospital with which it becomes associated or which modifies or expands its services so as to define all or part of the qualified healthcare facility 10. Further, the qualified healthcare facility 10 may provide a number of different healthcare services to patients in addition to the chronic care case management services.

In this regard, it is noted that the disproportionate share hospital embodiments may not have any restriction to the type of eligible patient that may be treated or the type of service that may be provided. A treatment staff retained by qualified healthcare facility 10 is also included as part of the present system, that treatment staff preferably including at least one physician 55. Also in this regard, the treatment staff may be directly retained by the affiliated healthcare facility and/or the parent FQHC or disproportionate share hospital entity, nevertheless, that treatment staff will be deemed employees of the qualified healthcare facility 10 and therefore are able to effectively offer healthcare services via the qualified healthcare facility 10.

Moreover, the treatment staff is preferably structured to remotely communicate with the patient 40, such as via the telephone or Internet, and preferably so as to obtain and maintain patient information which qualifies as a record of the patient's healthcare. Indeed, the treatment staff is structured to perform a patient contact sufficient to qualify the patient as a qualified patient of the qualified healthcare facility 10.

As previously recited, in one embodiment, the treatment staff is structured to at least partially establish patient contact by communicating, such as via telephone, with a prior care physician 20 that has physically examined the patient 40, and may directly obtain information to define the healthcare record and/or may obtain healthcare records from the prior care physician 20 or from a centralized health records storage and retrieval system in which the prior care physician 20 has stored, or arranged for a custodian to store, the records.

Although a variety of different healthcare services may be provided to the qualified patient 40, in one embodiment, at least one of the healthcare services provided is the chronic care preventive healthcare service whereby the treatment staff coordinates, reviews and advises the qualified patient 40 regarding at least one treatment plan being provided to the qualified patient 40 by an acting prior care physician 20, which in this or all embodiments may or may not be part of qualified healthcare facility 10. As a result, the qualified patient 40 is able to more effectively manage one or more treatment plans and recommendations can be effectively provided to the acting prior care physician 20 for implementation, if appropriate. In order to provide a pharmaceutical benefit to the qualified patient 40, healthcare facility 10 is also structured to obtain pharmaceuticals at a discounted cost utilizing the federal drug discount program, and to dispense those pharmaceuticals to the qualified patient at a reduced cost.

Although any number of different FQHC or disproportionate share hospitals may be provided to define the qualified healthcare facility 10 of the present system, in one embodiment, an Indian Tribal Healthcare Facility will act as the qualifying entity which can become associated with an affiliated healthcare center and/or can independently provide healthcare services and be deemed the qualified healthcare facility 10.

Referring again to FIG. 2, healthcare facility 10 determines if the qualified patient 40 has maintained a formal patient-physician relationship with the attending physician 55 or the physician's staff, at step 95. This may be determined by reviewing the patient-physician consult schedule to see if the patient 40 has missed any meetings, or if the patient has failed to provide updates to physician 55 or the physician's staff as to the patient's adherence to the treatment schedule outlined in their wellness program. If patient 40 has maintained a formal patient-physician relationship with the physician 55 or the physician's staff as agreed upon, the patient continues to be enrolled in the preventive healthcare program, at step 1 10. However, if patient 40 has not maintained a formal patient-physician relationship with the attending physician 55, the patient may be un-enrolled in the program, via step 105.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

We claim:

1. A method for enrolling one or more patients in a preventive healthcare program, the method comprising:
(a) storing at a healthcare facility a list of infirmities, each said infirmity including a corresponding list of symptoms, wherein the healthcare facility is a qualified member of the preventive healthcare program;
(b) receiving from a patient information regarding the status of the patient's health, wherein the health status includes one or more symptoms;
(c) upon receipt of the patient information, determining the infirmity corresponding to the one or more symptoms;
(d) generating a preventive healthcare program based upon one or more pre-established healthcare guidelines; and
(e) establishing a relationship between a physician affiliated with the preventive healthcare program and the patient in order to assure the patient's adherence to the preventive healthcare program.

2. The method of claim 1, wherein the preventive healthcare program includes dispensing discounted pharmaceuticals to the one or more patients.

3. The method of claim 1, further comprising qualifying the healthcare facility as a disproportionate share hospital eligible to participate in the preventive healthcare program.

4. The method of claim 3, wherein the healthcare facility is qualified as a disproportionate share hospital eligible to participate in the preventive healthcare program pursuant to section 340B of the Public Health Services Act.

5. The method of claim 2, wherein the patient's failure to maintain the relationship between the patient and the physician results in the dis-enrollment of the patient from the preventive healthcare program and the termination of the dispensed pharmaceuticals.

6. The method of claim 2, wherein the patient's failure to adhere to the preventive healthcare program results in the dis-enrollment of the patient from the preventive healthcare program and the termination of the discounted pharmaceuticals.

7. The method of claim 1, wherein the pre-established healthcare guideline is consistent with United States Preventive Services Task Force Guidelines.

8. The method of claim 1, wherein the relationship between the physician and the patient is established via telephone.

9. The method of claim 1, wherein the relationship between the physician and the patient is established via a computer network.

10. The method of claim 1, wherein the healthcare facility is a qualified member of the preventive healthcare program by virtue of its association with a separate healthcare facility, the separate healthcare facility already qualifying as a member of the preventive healthcare program.

11. A system for enrolling one or more patients in a preventive healthcare program, the system comprising:
(a) a healthcare facility, the healthcare facility being a qualified member of the preventive healthcare program;
(b) the healthcare facility including a database adapted to store a list of infirmities, each said infirmity including a corresponding list of symptoms;
(c) the healthcare facility adapted to receive from the patient a communication of the patient's current health status, the patient's current health status including at least one or more patient symptoms;
(d) means for determining one or more intervention procedures corresponding to the patient's one or more symptoms and for creating a preventive healthcare program corresponding to the one or more intervention procedures; and
(e) at least one physician associated with the preventive healthcare program, the at least one physician maintaining a relationship with the patient regarding the preventive healthcare program, wherein the patient's failure to maintain the relationship with the physician results in the dis-enrollment of the patient from the preventive healthcare program.

12. The system of claim 11, wherein the preventive healthcare program includes discounted pharmaceuticals dispensed to the one or more patients.

13. The system of claim 11, wherein the healthcare facility receives the communication of the patient's current health status via telephone.

14. The system of claim 11, wherein the healthcare facility receives the communication of the patient's current health status via a computer network.

15. The system of claim 11, wherein the relationship between the physician and the patient is established via telephone.

16. The system of claim 11, wherein the relationship between the physician and the patient is established via a computer network.

17. The system of claim 11, wherein the healthcare facility is qualified as a disproportionate share hospital eligible to participate in the preventive healthcare program pursuant to section 340B of the Public Health Services Act.

18. The system of claim 11, wherein the preventive healthcare program is consistent with United States Preventive Services Task Force Guidelines.

19. The system of claim 11, wherein the healthcare facility is a qualified member of the preventive healthcare program by virtue of its association with a separate healthcare facility, the separate healthcare facility already qualifying as a member of the preventive healthcare program.

20. The system of claim 12, wherein the patient's failure to adhere to the preventive healthcare program results in the dis-enrollment of the patient from the preventive healthcare program and the termination of the discounted pharmaceuticals.
